(19) United States
(12) Patent Application Publication
(10) Pub. No.: US 2021/0055898 A1
(43) Pub. Date: Feb. 25, 2021

(54) IMAGE FORMING APPARATUS AND CONTROL PROGRAM FOR IMAGE FORMING APPARATUS

(71) Applicant: Konica Minolta, Inc., Tokyo (JP)

(72) Inventor: Ken Miyazaki, Sagamihara-shi (JP)

(73) Assignee: Konica Minolta, Inc., Tokyo (JP)

(21) Appl. No.: 16/922,206

(22) Filed: Jul. 7, 2020

(30) Foreign Application Priority Data
Aug. 21, 2019 (JP) 2019-150952

(51) Int. Cl. G06F 3/12

(52) U.S. Cl. CPC G06F 3/1239; G06F 3/1251; G06F 3/1242; G06F 3/1219

(57) ABSTRACT

An image forming apparatus includes a hardware processor that, in a case where an image obtained by superimposing images in all pages included in one print job is defined as an overlay image, outputs a classification result of a group in which, when a plurality of the overlay images respectively corresponding to a plurality of the print jobs is assumed to be formed in a same page, a plurality of the print jobs respectively corresponding to a plurality of the overlay images determined not to overlap each other is classified into the same group, or performs an output based on the classification result.

The entire disclosure of Japanese patent Application No. 2019-150952, filed on Aug. 21, 2019, is incorporated herein by reference in its entirety.

### BACKGROUND

### Technological Field

The present invention relates to an image forming apparatus and a control program for the image forming apparatus.

### Description of the Related Art

A foil stamping technique has been known in which paper having a toner image formed thereon is superimposed on a foil, and heat and pressure are applied thereto to transfer the foil onto the toner image. The foil used for foil stamping is very expensive, and in view of this, a technique for suppressing wasteful consumption of the foil has been required. For example, JP 2018-151810 A discloses a technique for reducing the number of replacement times of a foil roll, while suppressing an amount of discarded foil by using a foil roll having a suitable width for each grouped job.

In the technique as disclosed in JP 2018-151810 A, a foil stamping operator may reuse the foil roll in consideration of a layout so that used areas of foil do not overlap, in order to suppress an amount of discarded foil. However, in order to reuse the foil, the operator needs to check in advance whether or not the used areas of foil overlap among multiple pieces of paper by, for example, superimposing the multiple pieces of paper having toner images formed thereon and seeing through the toner images. This is time-consuming and cumbersome. Further, when paper having a toner image formed thereon is, for example, thick or colored, it is difficult to see through the toner images by superimposing the multiple pieces of paper, and thus, the operator cannot accurately check overlapping of used areas of foil. In such a case, the foil may be wasted.

### SUMMARY

The present invention has been made in view of the abovementioned problems. Therefore, an object of the present invention is to provide an image forming apparatus capable of suppressing wasteful consumption of foil while improving productivity in foil stamping, and a control program for the image forming apparatus.

To achieve the abovementioned object, according to an aspect of the present invention, an image forming apparatus reflecting one aspect of the present invention comprises a hardware processor that, in a case where an image obtained by superimposing images in all pages included in one print job is defined as an overlay image, outputs a classification result of a group in which, when a plurality of the overlay images respectively corresponding to a plurality of the print jobs is assumed to be formed in a same page, a plurality of the print jobs respectively corresponding to a plurality of the overlay images determined not to overlap each other is classified into the same group, or performs an output based on the classification result.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view showing a schematic configuration of an image forming system according to an embodiment of the present invention;

FIG. 2 is a block diagram showing a schematic configuration of an image forming apparatus;

FIG. 3 is a block diagram showing a functional configuration of a controller of the image forming apparatus;

FIG. 4 is a diagram for describing overlapping of overlay images;

FIG. 5A is a diagram for describing overlapping of overlay images;

FIG. 5B is a diagram for describing overlapping of overlay images;

FIG. 6 is a flowchart showing an example of a procedure of processing of the image forming apparatus;

FIG. 7 is a diagram showing an example of a list screen indicating print jobs temporarily stored;

FIG. 8 is a diagram for describing an example of a procedure of processing for determining overlapping of overlay images;

FIG. 9 is a diagram showing an example of a screen for outputting a group classification result; and

FIG. 10 is a diagram showing an example of an operation screen according to first and second modifications.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, the same elements are denoted by the same reference numerals, and redundant description will be omitted. In addition, the dimensional ratios in the drawings are exaggerated for convenience of description, and may differ from actual ratios.

(Image Forming System)

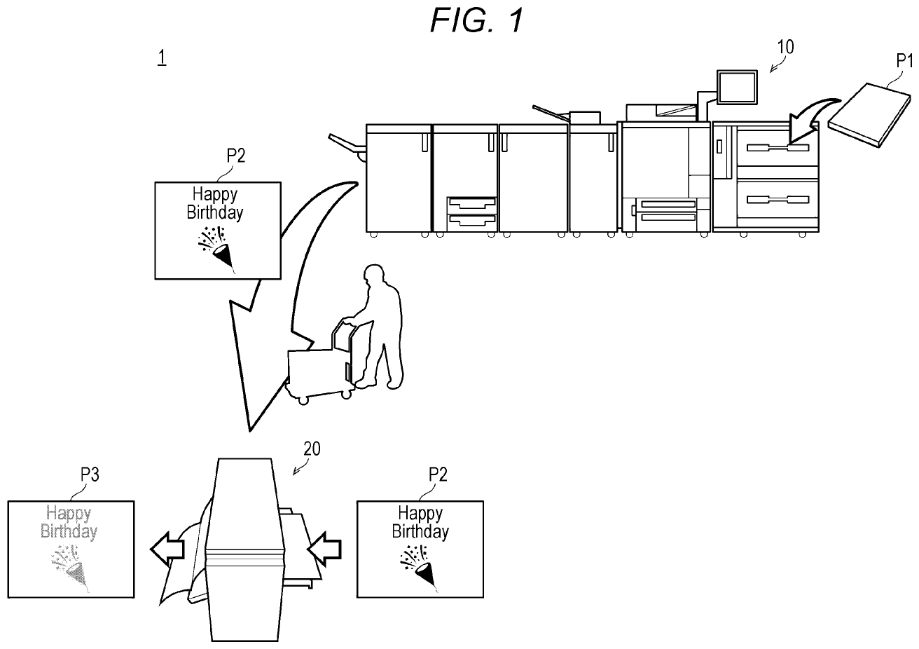

FIG. 1 is a view showing a schematic configuration of an image forming system according to an embodiment of the present invention.

As shown in FIG. 1, an image forming system 1 includes an image forming apparatus 10 and a foil stamping apparatus 20.

The image forming apparatus 10 forms, on paper P1, a toner image that is a target to which a foil is to be transferred by foil stamping, and outputs paper P2 on which the toner image is formed. The paper P2 on which the toner image is formed is manually carried by a foil stamping operator and set on the foil stamping apparatus 20.

The foil stamping apparatus 20 superimposes the paper P2 on which the toner image is formed on a foil which is in, for example, a roll shape, applies heat and pressure thereto to melt the toner, and transfers the foil onto the toner image using the melted toner as an adhesive. Then, the foil stamping apparatus 20 outputs a final printed matter P3 onto which the foil is transferred.

(Image Forming Apparatus)

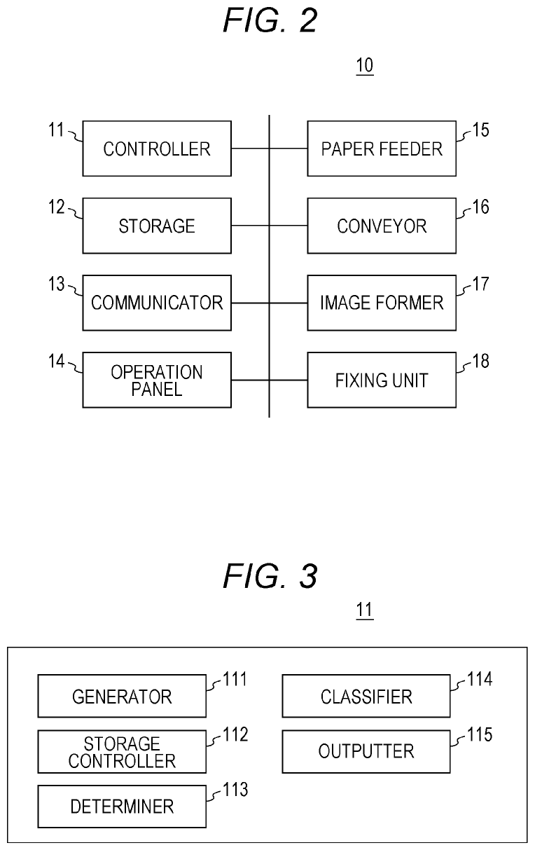

Next, details of the image forming apparatus 10 will be described. FIG. 2 is a block diagram showing the schematic configuration of the image forming apparatus.

As shown in FIG. 2, the image forming apparatus 10 includes a controller 11, a storage 12, a communicator 13, an operation panel 14, a paper feeder 15, a conveyor 16, an image former 17, and a fixing unit 18. The respective components are connected to each other via a bus for exchanging signals.

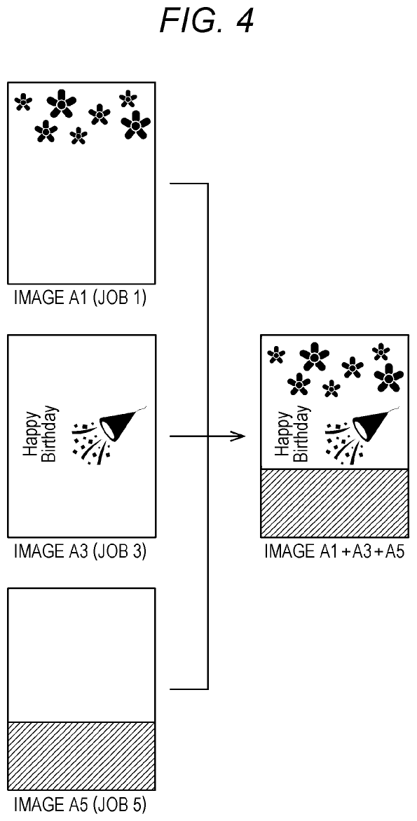

The controller 11 includes a central processing unit (CPU), and executes control of the respective components described above and various kinds of computing processes according to a program. The functional configuration of the controller 11 will be described later with reference to FIG. 3.

The storage 12 includes a read only memory (ROM) that stores various kinds of programs and various kinds of data in advance, a random access memory (RAM) that temporarily stores programs and data as a work area, a hard disk that stores various kinds of programs and various kinds of data, and the like. The storage 12 temporarily stores (holds) a print job for foil stamping, for example.

The communicator 13 includes an interface for communicating with other devices such as a personal computer (PC). The communicator 13 receives a print job from, for example, a PC used by the operator.

The operation panel 14 includes, for example, a touch panel, a numeric keypad, a start button, and a stop button. The operation panel 14 displays various kinds of information as a display, and receives various kinds of operations as an operation receiver.

The paper feeder 15 includes a paper feed tray that stores paper used for printing, and feeds the paper stored in the paper feed tray one by one.

The conveyor 16 includes a conveyance path, a plurality of conveyance rollers arranged along the conveyance path, and a drive motor for driving the conveyance rollers, and conveys the paper fed by the paper feeder 15 along the conveyance path.

The image former 17 forms an image on the paper conveyed by the conveyor 16 using a known image forming process such as an electrophotographic process.

The fixing unit 18 includes a heating roller and a pressure roller, and applies heat and pressure to the paper on which the image is formed by the image former 17 and which is conveyed by the conveyor 16, thereby fixing the image on the paper.

Note that the image forming system 1 and the image forming apparatus 10 may include components other than the abovementioned components, or may not include some of the abovementioned components.

(Controller)

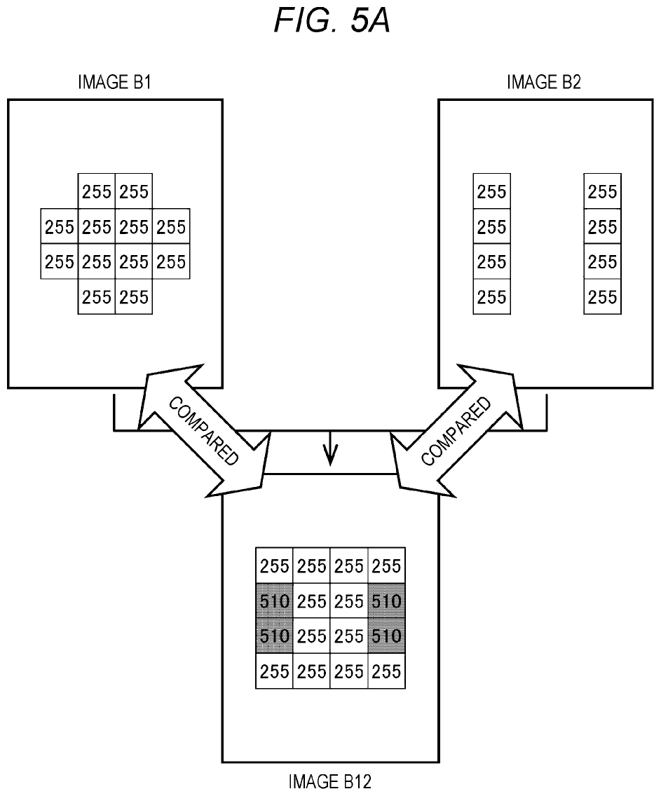

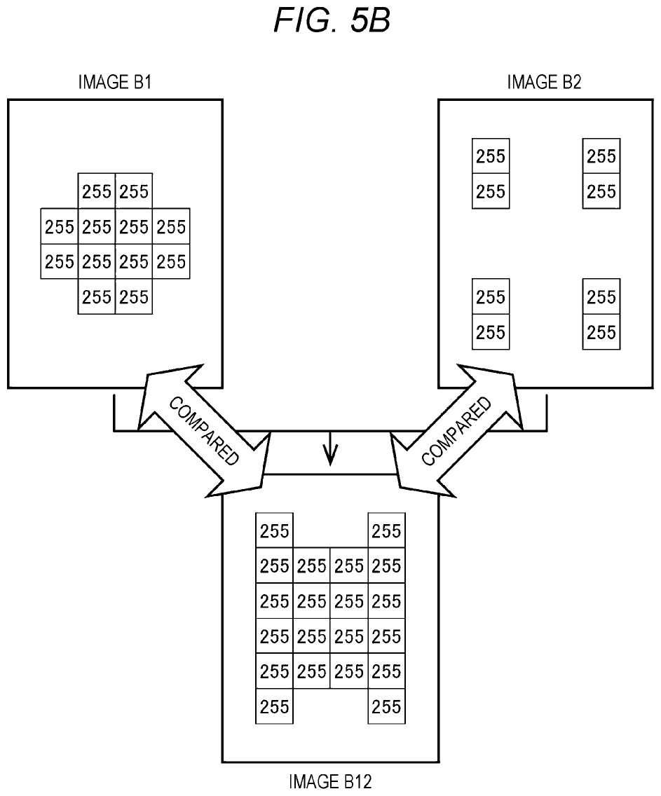

FIG. 3 is a block diagram showing a functional configuration of the controller of the image forming apparatus. FIGS. 4, 5A, and 5B are diagrams for describing overlapping of overlay images.

As shown in FIG. 3, the controller 11 functions as a generator 111, a storage controller 112, a determiner 113, a classifier 114, and an outputter 115 by reading the program and executing the processing.

The generator 111 generates an image (hereinafter, referred to as an “overlay image”) obtained by superimposing images in all pages included in one print job. For example, when one print job includes a plurality of pages, the generator 111 superimposes a plurality of images included in each of the plurality of pages to generate an overlay image. Further, when one print job includes only one page, the generator 111 outputs an image included in one page as an overlay image.

The storage controller 112 stores the overlay image in the storage 12.

The determiner 113 makes various determinations. For example, when it is assumed that multiple overlay images respectively corresponding to multiple print jobs are formed in the same page, the determiner 113 determines whether or not the multiple overlay images overlap each other. In the example shown in FIG. 4, an overlay image A1 which corresponds to a job A and which includes a plurality of flower designs, an overlay image A3 which corresponds to a job 3 and which includes a character of “Happy Birthday” and a design of a cracker, and an overlay image A5 which corresponds to a job 5 and which is black solid are arranged so as not to overlap one another even when they are formed in the same page. In this case, the determiner 113 determines that the multiple overlay images A1, A3, and A5 respectively corresponding to the jobs 1, 3, and 5 do not overlap each other.

Note that the determiner 113 may determine whether or not the multiple overlay images overlap each other on the basis of, for example, the density values (pixel values) of pixels included in the multiple overlay images. More specifically, the density values of black pixels included in the overlay images B1 and B2, respectively, and the density values of black pixels included in an image B12 obtained in the case where the overlay images B1 and B2 are assumed to be formed in the same page are calculated, and the density values of the black pixels are compared, as shown in FIGS. 5A and 5B, for example. In the example shown in FIG. 5A, the black pixels included in the image B12 partially have density values (black solid portions in FIG. 5A) different from the density values of the black pixels included in the overlay image B1 or B2. In this case, the determiner 113 determines that the overlay images B1 and B2 overlap each other. On the other hand, in the example shown in FIG. 5B, the black pixels included in the image B12 have the same density values as the density values of the black pixels included in the overlay image B1 or B2. In this case, the determiner 113 determines that the overlay images B1 and B2 do not overlap.

The classifier 114 classifies print jobs. More specifically, the classifier 114 classifies multiple print jobs respectively corresponding to multiple overlay images determined not to overlap each other into the same group. The classifier 114 classifies, for example, jobs 1, 3, and 5 as shown in FIG. 4 into the same group.

The outputter 115 outputs the group classification result. The outputter 115 outputs the group classification result by, for example, displaying it on the operation panel 14.

(Processing)

Subsequently, a procedure of processing of the image forming apparatus 10 will be described. The processing of the image forming apparatus 10 is to perform control so as to suppress wasteful consumption of foil while improving productivity in foil stamping.

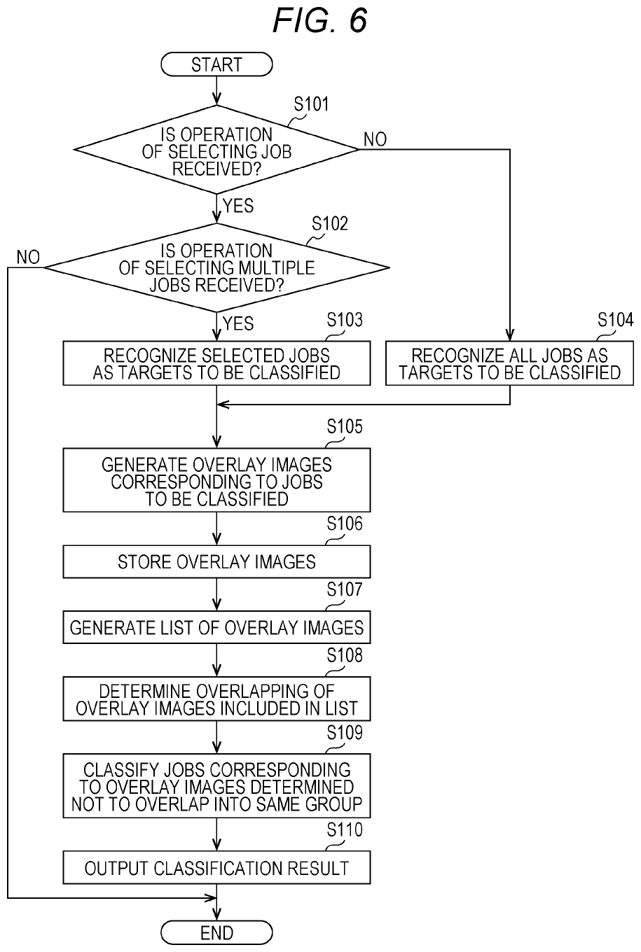

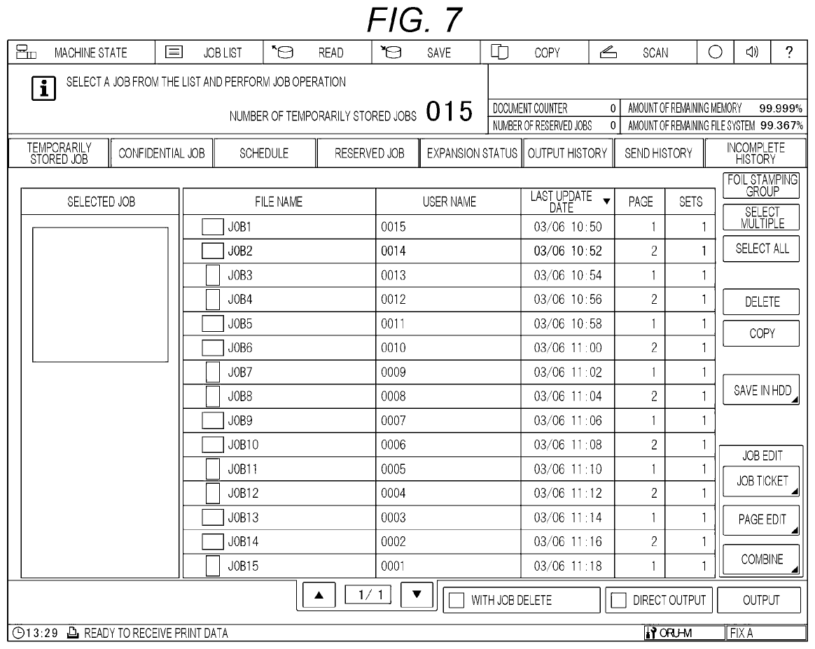

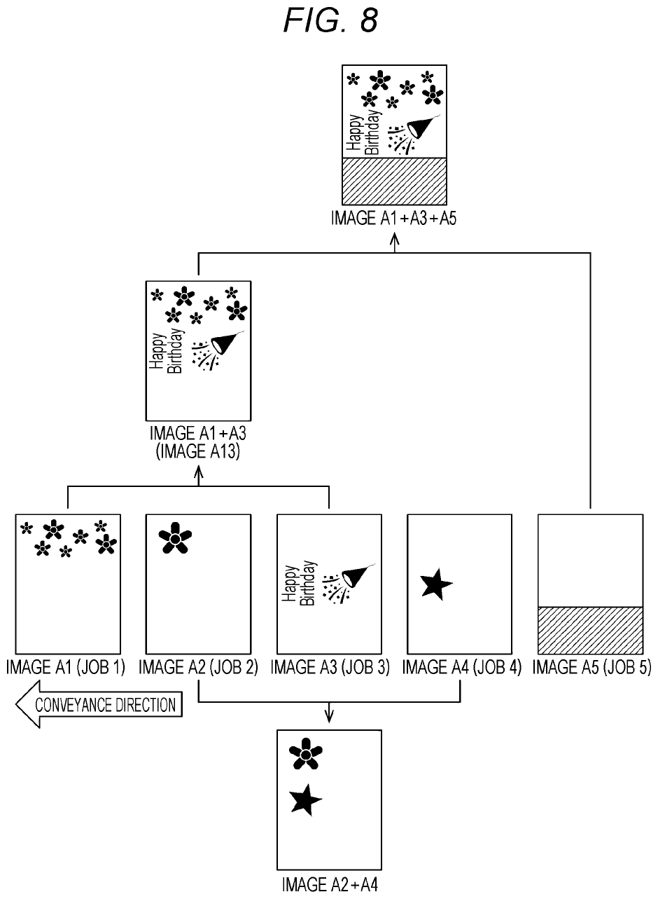

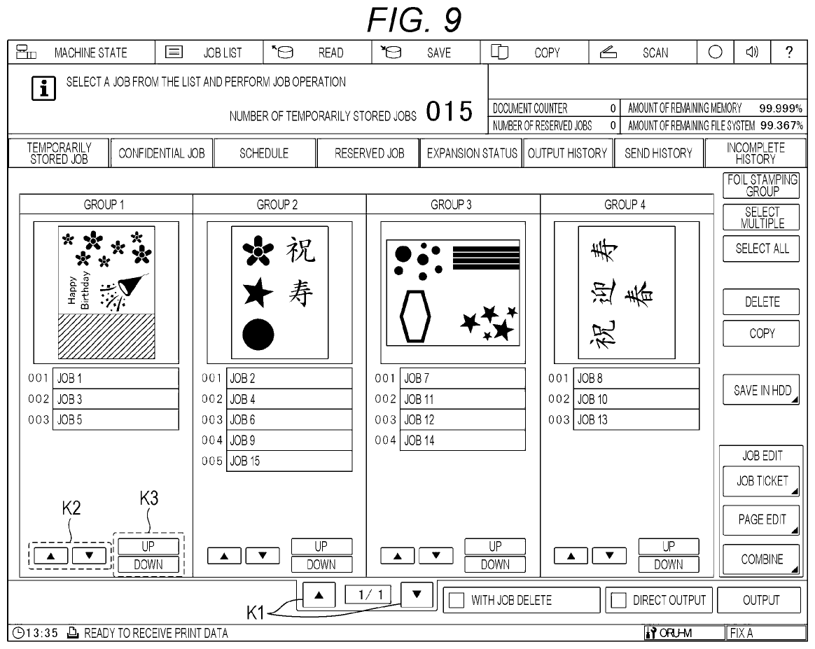

FIG. 6 is a flowchart showing an example of a procedure of the processing of the image forming apparatus. The processing algorithm shown in FIG. 6 is stored as a program in the storage 12, and is executed by the controller 11. FIG. 7 is a diagram showing an example of a list screen indicating print jobs temporarily stored. FIG. 8 is a diagram for describing an example of a procedure of processing for determining overlapping of overlay images. FIG. 9 is a diagram showing an example of a screen for outputting the group classification result.

As shown in FIG. 6, the controller 11 first determines, as the determiner 113, whether or not an operator's operation of selecting a print job temporarily stored in the storage 12 has been received in the operation panel 14 (step S101). The controller 11 determines whether or not an operation of selecting one or more print jobs is received in, for example, a list screen which is displayed in the operation panel 14 and which indicates the temporarily stored print jobs as shown in FIG. 7.

When determining that the operation of selecting print jobs has been received (step S101: YES), the controller 11 determines, as the determiner 113, whether or not an operator's operation of selecting multiple print jobs has been received (step S102).

When determining that the operation of selecting multiple print jobs has not been received, that is, an operation of selecting only one print job has been received (step S102: NO), the controller 11 ends the processing. Note that the controller 11 may terminate the processing after graying out a “foil-stamping group” soft key in the operation panel 14 shown in FIG. 7.

When determining that the operation of selecting multiple print jobs has been received (step S102: YES), the controller 11 recognizes, as the classifier 114, the selected print jobs as targets to be classified (step S103). Note that the controller 11 may proceed to the process of step S103 when determining that an operation of pressing the “foil-stamping group” soft key shown in FIG. 7 is received in the state where the print jobs are selected.

On the other hand, when determining that the operation of selecting multiple print jobs has not been received (step S101: NO), the controller 11 recognizes, as the classifier 114, all of the selected print jobs as targets to be classified (step S104). Note that the controller 11 may proceed to the process of step S104 when determining that the operation of pressing the “foil-stamping group” soft key shown in FIG. 7 is received in the state where the print jobs are not selected.

Subsequently, the controller 11 generates, as the generator 111, multiple overlay images respectively corresponding to the multiple print jobs recognized as the targets to be classified in step S103 or S104 (step S105). For example, the controller 11 generates overlay images corresponding to the print jobs in the order in which the print jobs are temporarily stored (for example, in order from the job 1 in the example shown in FIG. 7). Then, the controller 11 causes, as the storage controller 112, the storage 12 to store the generated overlay images (step S106). Then, the controller 11 generates, as the classifier 114, a list including the multiple overlay images stored in the storage 12 (step S107).

Subsequently, the controller 11 determines, as the determiner 113, overlapping of the multiple overlay images in a case where the multiple overlay images included in the list are assumed to be formed in the same page (step S108). Then, the controller 11 classifies, as the classifier 114, multiple print jobs respectively corresponding to multiple overlay images determined not to overlap each other into the same group (step S109).

For example, the controller 11 determines overlapping of the overlay images corresponding to the print jobs in the order in which the print jobs are temporarily stored, and classifies the print jobs into groups. In the example shown in FIG. 8, overlay images A1 to A5 corresponding to jobs 1 to 5 are generated. In this case, the controller 11 first determines whether or not the overlay image A1 corresponding to the job 1 which is the first print job and the overlay image A2 corresponding to the job 2 which is the next print job overlap each other if they are formed in the same page. In the example shown in FIG. 8, the overlay images A1 and A2 overlap, and therefore, the controller 11 does not classify the jobs 1 and 2 corresponding to the overlay images A1 and A2 into the same group.

Subsequently, the controller 11 determines whether or not the overlay image A1 and the next overlay image A3 overlap each other. In the example shown in FIG. 8, the overlay images A1 and A3 do not overlap, and therefore, the controller 11 classifies the jobs 1 and 3 corresponding to the overlay images A1 and A3 into the same group (for example, group 1).

Subsequently, the controller 11 determines whether or not an image A13 which is obtained if the overlay images A1 and A3 are formed in the same page overlaps the next overlay image A4. In the example shown in FIG. 8, the image A13 and the overlay image A4 overlap, and therefore, the controller 11 does not classify the jobs 1 and 3 corresponding to the image A13 and the job 4 corresponding to the overlay image A4 into the same group.

Subsequently, the controller 11 determines whether or not the image A13 and the next overlay image A5 overlap each other. In the example shown in FIG. 8, the image A13 and the overlay image A5 do not overlap, and therefore, the controller 11 classifies the jobs 1 and 3 corresponding to the image A13 and the job 5 corresponding to the overlay image A5 into the same group (for example, group 1).

Subsequently, the controller 11 determines whether or not the overlay image A2 corresponding to the job 2 which is not yet classified into any group and which is the first print job and the overlay image A4 corresponding to the job 4 which is the next print job overlap each other. In the example shown in FIG. 8, the overlay images A2 and A4 do not overlap, and therefore, the controller 11 classifies the jobs 2 and 4 corresponding to the overlay images A2 and A4 into the same group (for example, group 2). The controller 11 repeats the process of determining overlapping of overlay images and the process of classifying print jobs described above until the print jobs cannot be classified any more.

As shown in FIG. 8, in a case where multiple overlay images do not overlap even if they are supposed to be formed in the same page, it is considered that the used areas of foil do not overlap, even when the foil at the same position in the conveyance direction can be reused as the foil to be transferred to these images. That is, it is considered that the print jobs classified into the same group are print jobs which make it possible to reuse foil.

Returning to FIG. 6, the controller 11 outputs, as the outputter 115, the group classification result (step S110), and ends the processing. The controller 11 outputs the group classification result by, for example, displaying it on the operation panel 14 as shown in FIG. 9. In the example shown in FIG. 9, an image obtained when multiple overlay images respectively corresponding to multiple print jobs classified into the same group are assumed to be formed in the same page is displayed (in a thumbnail, for example) as the group classification result.

Further, in the screen displayed on the operation panel 14 that outputs the group classification result as shown in FIG. 9, an operator's operation of selecting one or more print jobs from the print jobs classified into each group may be received. Then, when the operation of selecting the print jobs is received, the overlay images corresponding to the selected print jobs from among the displayed images may be emphasized (highlighted).

In addition, the group classification result may not be displayed in one screen, because there are many print jobs to be classified into groups or there are many groups. In this case, the screen that outputs the group classification result may be scrolled when an operation of pressing a soft key K1 or K2 is received. Further, when the operation of pressing the “foil-stamping group” soft key is received, the screen for outputting the group classification result as shown in FIG. 9 may be changed to a list screen indicating temporarily stored print jobs as shown in FIG. 7.

When the operation of pressing an “output” soft key is received, the output of the printed matter based on the print jobs may be started. The print jobs classified into the same group may be collectively executed, and the execution order of the print jobs in the group may be changed when an operation of pressing a soft key K3 is received. Thus, the operator can recognize the print jobs to be executed collectively as print jobs which make it possible to reuse the foil.

The present embodiment provides the following effects.

In a case where an image obtained by superimposing images in all pages included in one print job is defined as an overlay image, the image forming apparatus 10 outputs a group classification result in which, when multiple overlay images respectively corresponding to multiple print jobs are assumed to be formed in the same page, multiple print jobs respectively corresponding to multiple overlay images that are determined not to overlap each other are classified into the same group, or performs an output based on the classification result. In a case where multiple overlay images do not overlap each other even if they are supposed to be formed in the same page, the used areas of foil do not overlap, even when the foil at the same position in the conveyance direction can be reused as the foil to be transferred to these images. Accordingly, the image forming apparatus 10 allows the foil stamping operator to accurately confirm a print job which makes it possible to reuse the foil by only confirming the group classification result, whereby the operator can easily reuse the foil. Therefore, the image forming apparatus 10 can suppress wasteful consumption of foil.

Further, the image forming apparatus 10 outputs the group classification result by displaying. Thus, the image forming apparatus 10 can allow the operator to confirm the group classification result.

Further, the image forming apparatus 10 displays, as the group classification result, an image obtained in a case where multiple overlay images respectively corresponding to multiple print jobs classified into the same group are assumed to be formed in the same page. Accordingly, the image forming apparatus 10 can allow the operator to confirm that the multiple overlay images do not overlap each other in an easily recognizable manner.

Further, when receiving an operator's operation of selecting one or more print jobs from among the print jobs classified into groups, the image forming apparatus 10 displays the overlay image corresponding to the selected print job in a highlighted manner. Accordingly, the image forming apparatus 10 can allow the operator to confirm the positions of the multiple overlay images respectively corresponding to the multiple print jobs in an easily recognizable manner.

The present invention is not limited only to the embodiment mentioned above, and various modifications and improvements are possible without departing from the scope of claims

(First Modification)

The abovementioned embodiment describes the case where the image forming apparatus 10 outputs the group classification result by displaying. However, the image forming apparatus 10 may output the group classification result by printing instead of or in addition to displaying. More specifically, the controller 11 of the image forming apparatus 10 may output, as the outputter 115, the group classification result by causing the image former 17 to print the group classification result.

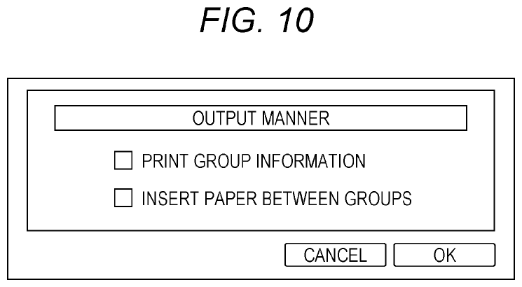

FIG. 10 is a diagram showing an example of an operation screen according to first and second modifications.

The operation screen as shown in FIG. 10 may be displayed after the operation of pressing the “output” soft key is received in the screen that is displayed in the operation panel 14 for outputting the group classification result shown in FIG. 9. Then, when the operator's operation for turning on a check box of “print group number” is received, the group classification result may be output by printing.

For example, the controller 11 may control the image former 17 such that information indicating the same group is printed on the back surface of paper on which the images included in the print jobs classified into the same group are formed. The information indicating a group may be a number, character, barcode, QR code, or the like indicating the group. Further, it is preferable that the information indicating a group is printed at a position such as an edge area of the paper or an area of the paper to be discarded, and the print position may be adjustable by the operator.

The first modification has the following effects.

The image forming apparatus 10 outputs the group classification result by printing. As a result, the operator can confirm the printed group classification result even if he/she cannot confirm the group classification result displayed in the image forming apparatus 10.

Further, the image forming apparatus 10 prints information indicating the same group on the back surface of paper on which the images included in the print jobs classified into the same group are formed. As a result, the image forming apparatus 10 does not need to transfer the foil to the printed information indicating the group, whereby wasteful consumption of the foil can be suppressed.

(Second Modification)

The first modification describes, as one example, the case where the image forming apparatus 10 prints the information indicating the group on the back surface of paper. However, there may be a case in which the image forming apparatus 10 cannot print the information indicating a group on the back surface of paper, such as a case in which an image is formed on paper such as a thick paper to which double-sided printing is impossible.

In view of this, the image forming apparatus 10 may output the group classification result by inserting partition paper in place of or in addition to printing. More specifically, the controller 11 of the image forming apparatus 10 may perform, as the outputter 115, an output based on the group classification result by causing the conveyor 16 to convey partition paper between paper on which an image included in a print job classified into a certain group is formed and paper on which an image included in a print job classified into another group is formed. Accordingly, the operator can confirm the group classification result according to the position of the partition paper.

Note that, when an operator's operation of turning on a check box of “insert partition paper between groups” is received in the operation screen shown in FIG. 10, the image forming apparatus 10 may perform an output based on the group classification result by inserting partition paper. Further, the image forming apparatus 10 may feed the partition paper from a predetermined paper feed tray or from a manual feed tray, and may set a paper source of the partition paper according to the operator's operation of setting the paper source of the partition paper.

Alternatively, the image forming apparatus 10 may perform an output based on the group classification result by changing the discharge tray instead of inserting the partition paper. More specifically, the controller 11 of the image forming apparatus 10 may perform, as the outputter 115, an output based on the group classification result by causing the conveyor 16 to convey paper on which an image included in a print job classified into a certain group is formed and paper on which an image included in a print job classified into another group is formed onto different discharge trays. Accordingly, the operator can confirm the group classification result according to the position of discharge tray.

Alternatively, the image forming apparatus 10 may perform an output based on the group classification result by suspending the print job instead of inserting partition paper or changing the discharge tray. More specifically, the controller 11 of the image forming apparatus 10 may perform, as the outputter 115, an output based on the group classification result by performing control such that, before a print job classified into another group is executed after the execution of a print job classified into a certain group, the execution of the print job is suspended. Accordingly, the operator can confirm the group classification result according to the suspension of the print job. Note that, in the case where the print job is suspended, the image forming apparatus 10 may restart the execution of the print job when receiving an operator's operation of restarting the execution of the print job.

In addition, in the above embodiment, the image forming apparatus 10 may generate the overlay image as a thumbnail image by reducing an image size. As a result, the image forming apparatus 10 can reduce the processing load, and can increase the processing speed of the process of determining overlapping, for example.

Further, the above embodiment describes, as one example, the case where the image forming apparatus 10 uses toner to form an image to which a foil is to be transferred. However, the image forming apparatus 10 may be an inkjet printer, and may form an image to which a foil is to be transferred using varnish instead of ink.

The processes according to the above embodiment may include steps other than the steps mentioned above, or may not include some of the steps mentioned above. Further, the order of the steps is not limited to the order described in the above embodiment. Furthermore, the steps may be combined with other steps and executed as a single step, may be included in another step, may be divided into a plurality of steps, or may be executed simultaneous with other steps.

The means and method for performing various types of processing in the image forming apparatus 10 according to the above embodiment can be achieved by either a dedicated hardware circuit or a programmed computer. The abovementioned program may be provided by a computer-readable recording medium such as a compact disc read only memory (CD-ROM), or may be provided online via a network such as the Internet. In this case, the program recorded on the computer-readable recording medium is usually transferred to and stored in a storage such as a hard disk. Further, the abovementioned program may be provided as a single piece of application software, or may be incorporated into the software as one function of the image forming apparatus 10.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming apparatus comprising a hardware processor that, in a case where an image obtained by superimposing images in all pages included in one print job is defined as an overlay image, outputs a classification result of a group in which, when a plurality of the overlay images respectively corresponding to a plurality of the print jobs is assumed to be formed in a same page, a plurality of the print jobs respectively corresponding to a plurality of the overlay images determined not to overlap each other is classified into the same group, or performs an output based on the classification result.

2. The image forming apparatus according to claim 1, wherein
the hardware processor generates the overlay image,
the hardware processor determines, when a plurality of the overlay images generated by the hardware processor is assumed to be formed in a same page, whether or not the plurality of the overlay images overlap each other,
the hardware processor classifies a plurality of the print jobs respectively corresponding to a plurality of the overlay images determined not to overlap each other by the hardware processor into the same group, and
the hardware processor outputs the classification result of the hardware processor or performs an output based on the classification result.

3. The image forming apparatus according to claim 2, wherein the hardware processor generates the overlay image as a thumbnail image.

4. The image forming apparatus according to claim 1, further comprising a display, wherein
the hardware processor outputs the classification result by causing the display to display the classification result.

5. The image forming apparatus according to claim 4, wherein
the hardware processor displays, in the display, an image obtained when the plurality of the overlay images respectively corresponding to the plurality of the print jobs classified into the same group is assumed to be formed in the same page, as the classification result.

6. The image forming apparatus according to claim 5, further comprising an operation receiver, wherein,
when an operator's operation of selecting one or more of the print jobs that are displayed in the display and that are classified into the group is received by the operation receiver, the hardware processor causes the display to display the overlay image corresponding to the selected print job in a highlighted manner.

7. The image forming apparatus according to claim 1, further comprising an image former, wherein
the hardware processor outputs the classification result by causing the image former to print the classification result.

8. The image forming apparatus according to claim 7, wherein
the hardware processor causes the image former to print information indicating the same group on a back surface of paper on which the image included in the print job classified into the same group is formed.

9. The image forming apparatus according to claim 1, further comprising a conveyor, wherein
the hardware processor performs an output based on the classification result by causing the conveyor to convey and insert partition paper between paper on which the image included in the print job classified into one group included in the group is formed and paper on which the image included in the print job classified into another group included in the group is formed.

10. The image forming apparatus according to claim 1, further comprising a conveyor, wherein
the hardware processor performs an output based on the classification result by causing the conveyor to convey paper on which the image included in the print job classified into one group included in the group is formed and paper on which the image included in the print job classified into another group included in the group is formed onto different discharge trays.

11. A non-transitory recording medium storing a computer readable control program for an image forming apparatus, the control program causing a computer to perform a process including outputting, in a case where an image obtained by superimposing images in all pages included in one print job is defined as an overlay image, a classification result of a group in which, when a plurality of the overlay images respectively corresponding to a plurality of the print jobs is assumed to be formed in a same page, a plurality of the print jobs respectively corresponding to a plurality of the overlay images determined not to overlap each other is classified into the same group, or performing an output based on the classification result.

12. The non-transitory recording medium storing a computer readable control program according to claim 11, wherein the process further includes:
generating the overlay image;
determining, when a plurality of the generated overlay images is assumed to be formed in a same page, whether or not the plurality of the overlay images overlap each other; and
classifying a plurality of the print jobs respectively corresponding to the plurality of the overlay images determined not to overlap each other into the same group, wherein
the outputting performs an output of the classification result obtained by the classifying or performs an output based on the classification result.

13. The non-transitory recording medium storing a computer readable control program according to claim 12, wherein the generating generates the overlay image as a thumbnail image.

14. The non-transitory recording medium storing a computer readable control program according to claim 11, wherein the outputting outputs the classification result by causing a display provided in the image forming apparatus to display the classification result.

15. The non-transitory recording medium storing a computer readable control program according to claim 14, wherein the outputting displays, in the display, an image obtained when a plurality of the overlay images respectively corresponding to the plurality of the print jobs classified into the same group is assumed to be formed in the same page, as the classification result.

16. The non-transitory recording medium storing a computer readable control program according to claim 15, wherein the outputting, when an operator's operation of selecting one or more of the print jobs that are displayed in the display and that are classified into the group is received by an operation receiver provided in the image forming apparatus, displays the overlay image corresponding to the selected print job in the display in a highlighted manner.

17. The non-transitory recording medium storing a computer readable control program according to claim 11, wherein the outputting outputs the classification result by causing an image former provided in the image forming apparatus to print the classification result.

18. The non-transitory recording medium storing a computer readable control program according to claim 17, wherein the outputting controls the image former to print information indicating the same group on a back surface of paper on which the image included in the print job classified into the same group is formed.

19. The non-transitory recording medium storing a computer readable control program according to claim 11, wherein the outputting performs an output based on the classification result by causing a conveyor provided in the image forming apparatus to convey and insert partition paper between paper on which the image included in the print job classified into one group included in the group is formed and paper on which the image included in the print job classified into another group included in the group is formed.

20. The non-transitory recording medium storing a computer readable control program according to claim 11, wherein the outputting performs an output based on the classification result by causing a conveyor provided in the image forming apparatus to convey paper on which the image included in the print job classified into one group included in the group is formed and paper on which the image included in the print job classified into another group included in the group is formed onto different discharge trays.
